(19) United States
(12) Patent Application Publication
(10) Pub. No.: US 2015/0361267 A1
(43) Pub. Date: Dec. 17, 2015

(54) Process for the Synthesis of Precursor Complexes of Titanium Dioxide Sensitization Dyes Based on Ruthenium Polypyridine Complexes

(71) Applicant: DYEPOWER, Rome (IT)

(72) Inventors: Rita BOARETTO, Rome (IT); Eva BUSATTO, Rome (IT); Stefano CARLI, Rome (IT); Sandro FRACASSO, Rome (IT); Stefano CARAMORI, Rome (IT); Carlo Alberto BIGNOZZI, Rome (IT)

(21) Appl. No.: 14/701,019

(22) Filed: Apr. 30, 2015

Related U.S. Application Data
(63) Continuation-in-part of application No. 13/908,305, filed on Jun. 3, 2013, now abandoned.
Application No. 13/908,305 is a continuation of application No. PCT/IT2011/000397, filed on Dec. 2, 2011.

(30) Foreign Application Priority Data
Dec. 3, 2010 (IT) RM2010A000630

(51) Int. Cl. C09B 67/00

(52) U.S. Cl. CPC C09B 68/28

(57) ABSTRACT

The present invention concerns a process for the synthesis of both precursor complexes and dye sensitizers for titanium dioxide based on ruthenium polypyridine complexes comprising microwave irradiation, under high pressure and in aqueous environment system

### CROSS-REFERENCE TO RELATED APPLICATIONS

This application is a continuation-in-part of U.S. patent application Ser. No. 13/908,305 filed on Jun. 3, 2013, which is a continuation of PCT International Application PCT/IT2011/000397, filed Dec. 2, 2011. The entire disclosures of each of the above applications are incorporated herein by reference.

### FIELD

The present invention concerns a process for the synthesis of both precursor complexes and dye sensitizers for titanium dioxide sensitization based on ruthenium polypyridine complexes.

### DETAILED DESCRIPTION

More particularly, the invention concerns synthetic methodologies, using microwave irradiation under high pressure in aqueous environment, of precursor complexes and sensitizers based on ruthenium polypyridine complexes functionalized with carboxylic groups.

Such dyes are used as sensitizers for titanium dioxide, a wide band-gap semiconductor used in photoelectrochemical cells, that is solar cells, also named, according to English terminology, Dye-Sensitized Solar Cells, or DSSC (O'Reagan, B.; Graetzel, M. Nature 1991. 353. 737-739 [A low cost high-efficiency solar cell based on dye-sensitized colloidal TiO₂ films]).

DSSCs are photoregenerative solar cells consisting of photoanode wherein a titanium dioxide semiconductor layer is present coated on a conductive glass substrate, sensitized by at least one chromophore compound; a counter-electrode; and an electrolyte therebetween.

As it is well known, main requirements a dye molecule must display so that it can be considered a good spectral semiconductor sensitizer can be reassumed according to the following points:
stable adsorption on semiconductor surface in the presence of an electrolyte;
high light absorption within visible and near infrared spectral regions;
sufficiently negative excited state redox potential to assure the electron jump into semiconductor conduction band;
fundamental state redox potential such to allow an efficient oxidation of electronic mediator;
low rearrangement energy for electron transfer into excited and fundamental state, respectively, in order the energy loss associated to such processes to be minimized.

Many organic and inorganic compounds have been evaluated as semiconductor sensitizers, like for example chlorophyll derivatives, porphyrins, phthalocyanins, platinum fluorescent complexes, dyes, carboxylic functional anthracene derivatives, polymer films, titanium dioxide coupled lower band-gap semiconductors, etc. Also vegetal extracts have been used like natural sensitizers for solar cells (Garcia, C. G.; Pole, A. S; Murakami Iha, N. Y. J photochem. Photobiol. A 2003.160.87 [Natural dyes applied to TiO2 sensitization in photochemical cells]). The fundamental point emerging from these studies remains, however, that the best conversion efficiency of solar energy in electric power is obtained with ruthenium (II) polypyridine complexes wherein carboxylic ligands, used as titanium dioxide sensitizers are present. These molecular species result in intense visible absorption bands attributed to metal-ligand charge transfer (MLCT) transitions.

For the series of complexes with general formula cis-[Ru(H₂dcbpy)₂(X)₂] (X being selected from Cl⁻, Br⁻, I⁻, NCS⁻ and CN⁻), MLCT absorption band and maximum emission have been found to be shifted to values of higher wavelength according to the decrease of field strength of ligand X, with decrease of fundamental state redox potential, E½ Ru (^{III})/(^{II}), according to expected order CN>NCS>halides. In general terms, these complexes are nanocrystal TiO₂ efficient sensitizers, allowing the charge injection into conduction band thereof through irradiation with visible light (400-800 nm). In particular, the performances of complex (1) with NCS ligands (called N3) proved to be excellent (Nazeeruddin, M. K.; Kay, To; Rodicio, R.; Humphry-Baker, R.; Muller, And; Liska, P.; Vlachopoulos, M.; Graetzel, M. J. Am. Chem. Soc. 1993. 115. 6382 [The preparation and the photoelectrochemical characterization of a new family of highly efficient dyes is reported]) resulting in an overall conversion efficiency of the order of 10%.

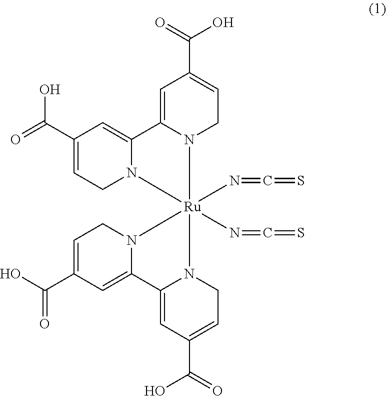

Successively, a large number of dyes have been synthesized without reaching N3 sensitizer efficiency, up to 2000 years, when in Grätzel directed laboratory dye (2), named N719. displaying an efficiency of 10.85% under simulated solar irradiation (AM 1.5) was found (Nazeeruddin, K.; Zakeeruddin, S. M.; Humphry-Baker, R., Jirousek, M.; Liska, P.; Vlachopoulos. N; Shklover, V.; Fisher, C. H.; Grätzel, M. Inorg. Chem., 38. 26. 6298-6305. 1999).

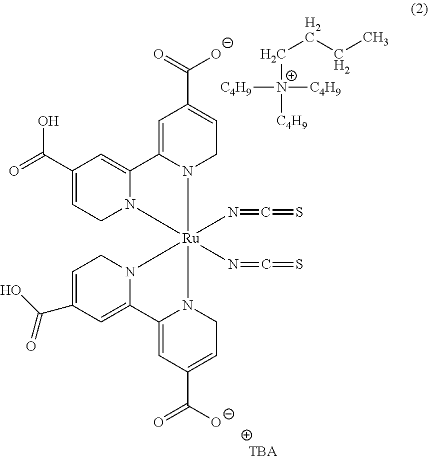

The sensitizer plays a key role in determining the cell efficiency value. For DSSC applications in outdoor atmospheres, specifically for wide area applications, many factors display to be significant: technical performances and structure, echo compatibility, costs, dyeing, design and long term stability.

However, according to thermal traditional synthesis of N3 and N719 dyes, disclosed chemical processes and purification procedures result in very expensive dyes. The use of toxic solvents like dimethylformamide (DMF) makes large scale synthesis not available from the point of view of environmental impact.

An example of synthesis procedure of these compounds is disclosed in European Patent Applications No. EP1798222 and No. EP2116534. referring to synthesis of (H₂dcbpy)₂RuCl₂ complex comprising the reaction of H₂dcbpy with RuCl₃.3H₂O in N,N-dimethylformamide, under microwave irradiation and atmospheric pressure.

In the light of above, it is apparent the need to produce such sensitizing dyes according to alternative more economic methodologies, using echo-compatible solvents and reduced reaction times.

In this context it is disclosed the solution according to the present invention, aiming to provide for a synthesis procedure of titanium dioxide sensitizers based on ruthenium polypyridine complexes and their precursors, using water based solvents and pressurized microwave reactor, to be improved.

The process which is the object of the present invention allows various molecular species using not toxic solvents to be produced, high product yields to be obtained and very short reaction times to be used when compared to conventional thermal syntheses.

The object of the present invention is therefore to propose a synthetic process for precursor complexes and titanium dioxide sensitizers allowing the drawbacks according to known technology to be overcome and the above reported technical results to be obtained.

A further object of the invention is that said synthesis process can be embodied at substantially reduced costs, both as to production and operation costs.

Not last object of the invention is to propose a synthetic process for precursor complexes and titanium dioxide sensitizers substantially simple, safe and reliable.

It is therefore a first specific object of the present invention a process for the synthesis of both precursor complexes and dye sensitizers for titanium dioxide based on functionalised ruthenium polypyridine complexes comprising microwave irradiation, frequency being comprised between 300 MHz and 300 GHz, under high pressure system, pressure value being comprised between 690 and 5500 kPa in aqueous media.

In particular both precursor complexes and dye sensitizers for titanium dioxide were based on ruthenium polypyridine complexes of general formula RuLL′X₂, RuLX₃ or Ru LL′L″, where L, L′, L″ is a bidentate or tridentate organic ligand which can be chosen among H₂dcbpy 4,4′-dicarboxy-2-2′-bipyridyl, 5.5′ H₂dcbpy 5,5′-dicarboxy-2,2′-bipyridyl, 4,4′,4″-tricarboxy-2,2′,6′,2″-terpyridyl, 4,4′-dinonyl-2,2′-bipyridyl, 4,4′-bis-3.4-dioctyloxystyryl-2,2′-bipyridyl, 6-phenyl-2,2′-bipyridyl, 6-(2,4-difluorophenyl)-2,2′-bipyridyl; where the X are independently a monoanionic ligand, for example selected from NCS⁻, CN⁻, Cl⁻, and Br⁻. Ruthenium precursors include RuCl₃.3(H₂O), [RuCl₆]²⁻, and [Ru(DMSO)₆(Y)₂], wherein Y is a monoanion, for example selected from PF₆, ClO₄, Cl, and Br dissolved in an amount of 60-70 mL per gram of metal precursor of a solution comprising from 20 to 100% by weight of water and from 0 to 80% of HCl (37%).

Further according to the invention, said microwave irradiation (magnetron frequency 2.45 GHz) is carried out at a temperature comprised between 80 and 250° C., at a power comprised between 400 and 1600 W for a time comprised between 10 and 60 minutes.

Further again according to the present invention, following said microwave irradiation, the synthesis products are cooled to room temperature, separated by filtration, washed with water or HCl solution and dried.

The precursor complexes of titanium dioxide sensitizers obtainable according to the process as above defined are a second specific object of the present invention.

A synthesis process of titanium dioxide sensitizing dyeing complexes based on ruthenium polypyridine complexes comprising microwave irradiation, (magnetron frequency 2.45 GHz), under high pressure system, pressure value being comprised between 690 and 5500 kPa and under an aqueous system, of precursor complexes and sensitizers obtainable by means of the process as above defined in mixture with a NCS⁻ or CN⁻ salt (from 10 to 50 equivalents) or with a chelating chromophore ligand based on polypyridine, polytriazole, polytetrazole and acetylacetonate derivatives (from 1 to 4 equivalents) is a third specific object of the present invention.

Preferably according to the invention, said microwave irradiation is carried out at a temperature comprised between 80 and 250° C., at a power comprised between 400 and 1600 W for a time comprised between 10 and 60 minutes, and following said microwave irradiation the synthesis products are cooled to ambient temperature, separated by precipitation, washed and dried.

Titanium dioxide dye sensitizers obtainable according to the process as defined in above two paragraphs represent a fourth specific object of the present invention.

The use of titanium dioxide dye sensitizers obtainable according to the process as above defined in electrophotochemical cells represents a fifth specific object of the present invention.

Therefore, when compared to the conventional thermal syntheses, it is apparent the effectiveness of the synthesis process of precursor complexes and titanium dioxide sensitizers of the present invention, allowing various molecular species using not toxic solvents and very short reaction times to be produced, high product yields to be obtained.]

The invention will be described by an illustrative, but not limitative way with particular reference to some illustrative examples and enclosed figures, wherein:

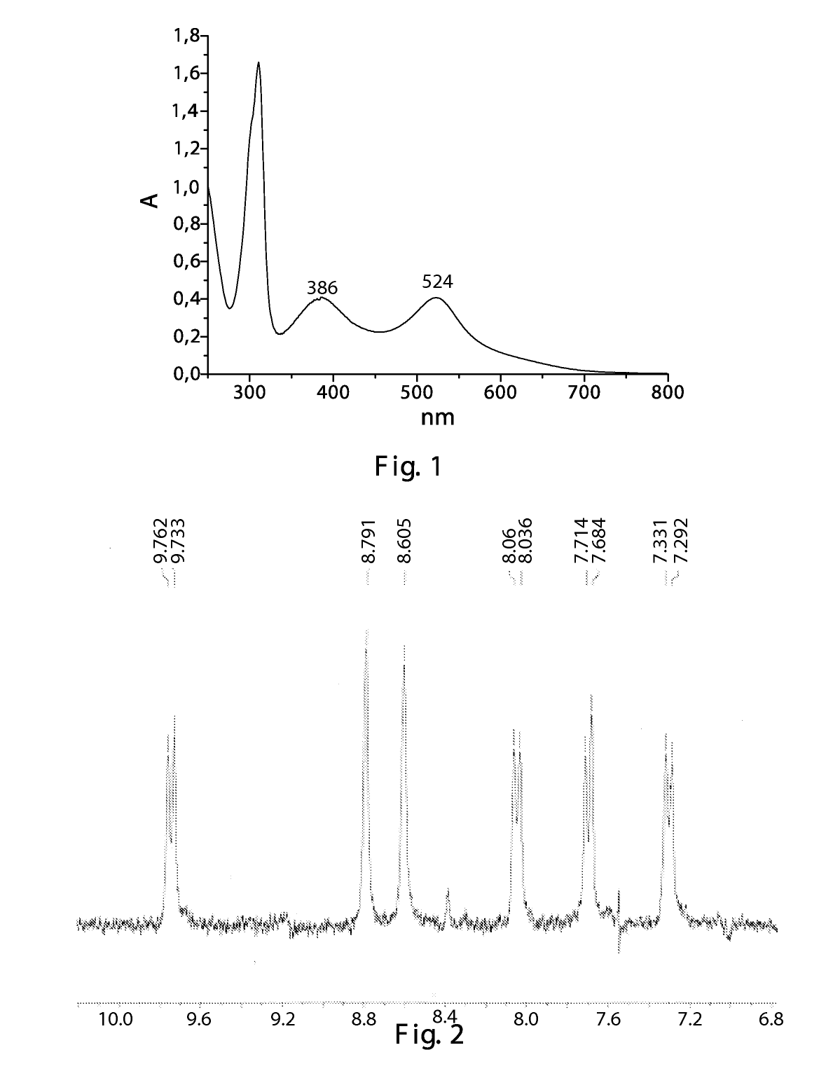

FIG. 1 shows UV-Vis spectra in basic aqueous solution of the complex Ru(II)(H₂DCBPy)₂Cl₂ from example 1;

FIG. 2 shows ¹H NMR spectra in D₂O and NaOD of the complex Ru(II)(H₂DCBPy)₂Cl₂ from example 1;

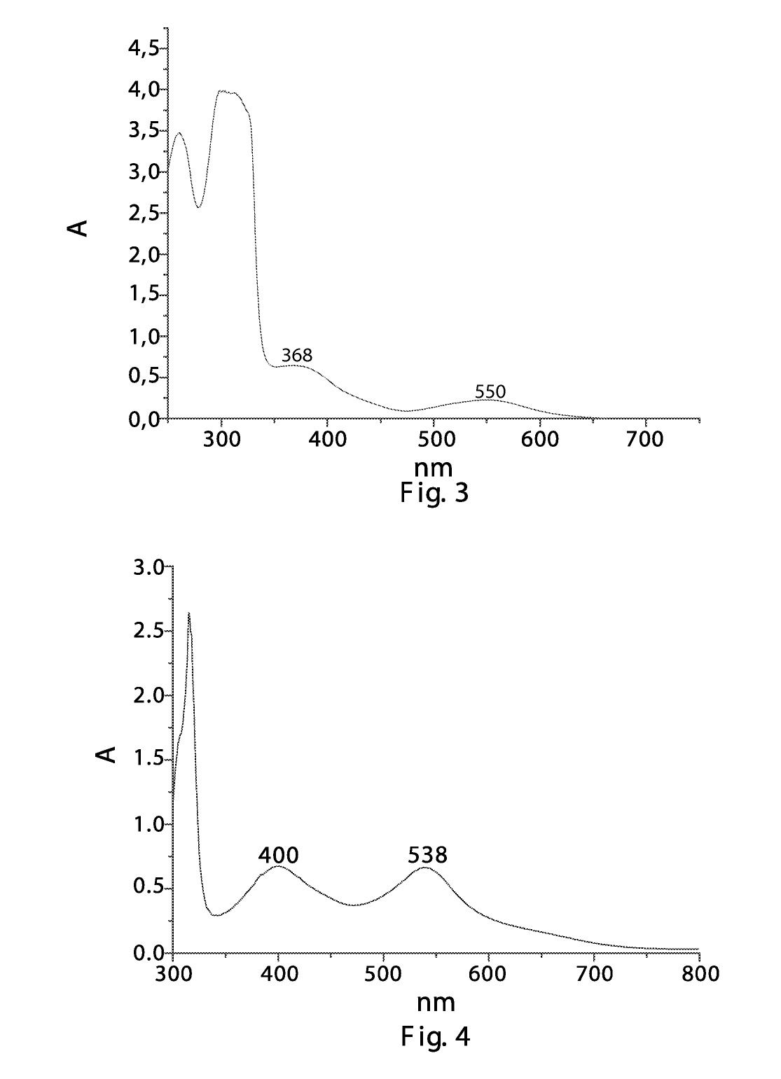

FIG. 3 shows UV-Vis spectra in MeOH+NaOH of the complex Ru(II)(5.5′H₂DCBPy)₂(NCS)₂(N3) from example 3;

FIG. 4 shows UV-Vis spectra in EtOH of the complex Ru(II)(H₂DCBPy)₂(NCS)₂ (N3) from example 4;

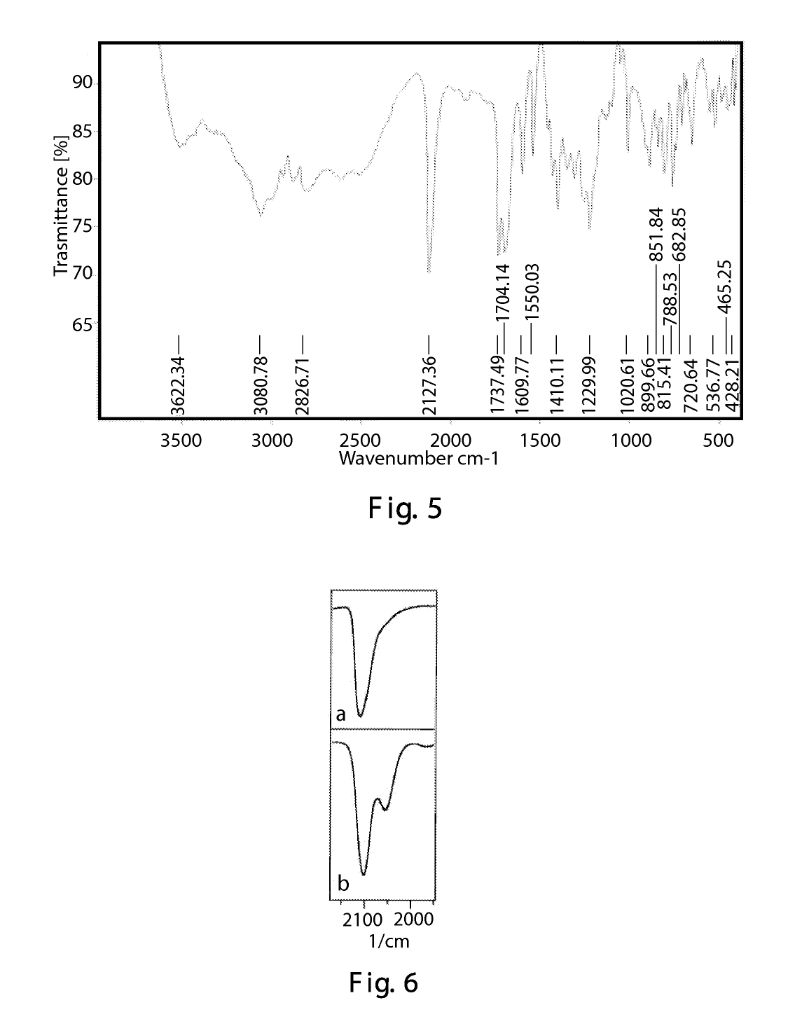

FIG. 5 shows FT-IR spectra of the complex Ru(II)(H₂DCBPy)₂(NCS)₂ (N3) from example 4;

FIG. 6 shows the range from 2000 to 2200 cm⁻¹ of FT-IR spectra for the complex Ru(II)(H₂DCBPy)₂(NCS)₂ (N3) from example 4 (a) and a sample of said complex containing 21%-S and 79%-N coordinated according to known art (b);

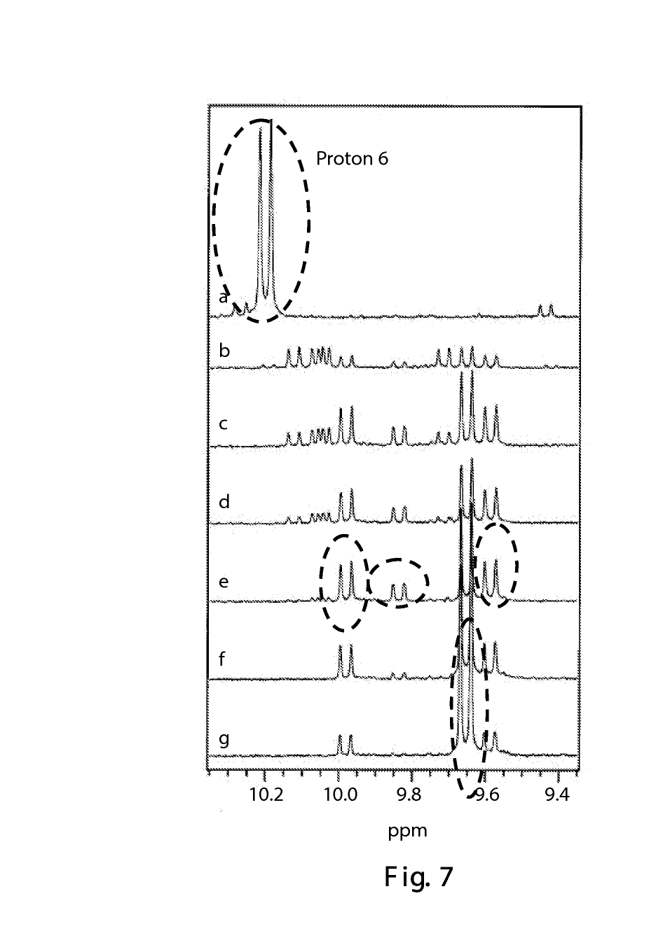

FIG. 7 shows the time evolution of sequential ¹H NMR spectra recorded on a batch of (a). Ru(II)(H₂DCBPy)₂Cl₂ complex in presence of thiocyanate before heating (b) after heating at 55° C. for 1 hour, (c) after a further 1 hour at 55° C., (d) after 12 hours at room temp., (e) after 2 hours at 55° C., (f) after 2 hours at 55° C., (g) 16 hours at 75° C.;

FIG. 8 shows ¹H NMR spectra in D₂O and NaOD of the complex Ru(II)(H₂DCBPy)₂(NCS)₂ (N3) from example 4;

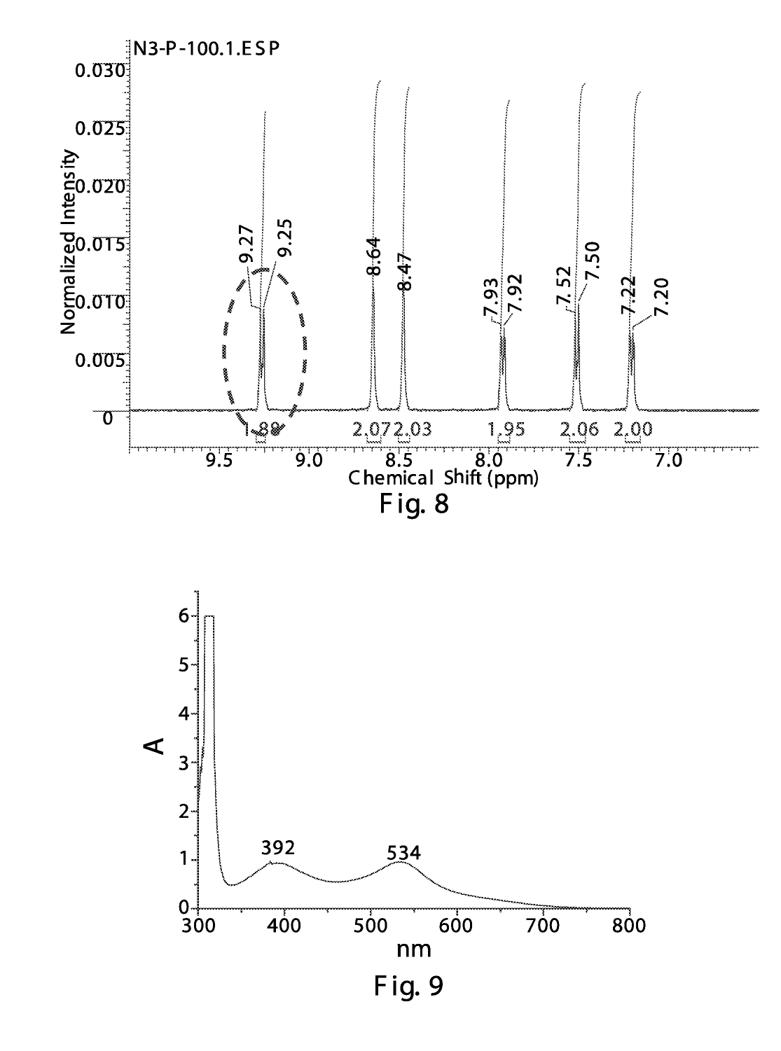

FIG. 9 shows UV-Vis spectra in EtOH of the complex from Ru(II)(TBAHDCBPy)₂(NCS)₂ (N719) example 5;

FIG. 10 shows ¹H NMR spectra in D₂O and NaOD of the complex Ru(II)(TBAHDCBPy)₂(NCS)₂ (N719) from example 5;

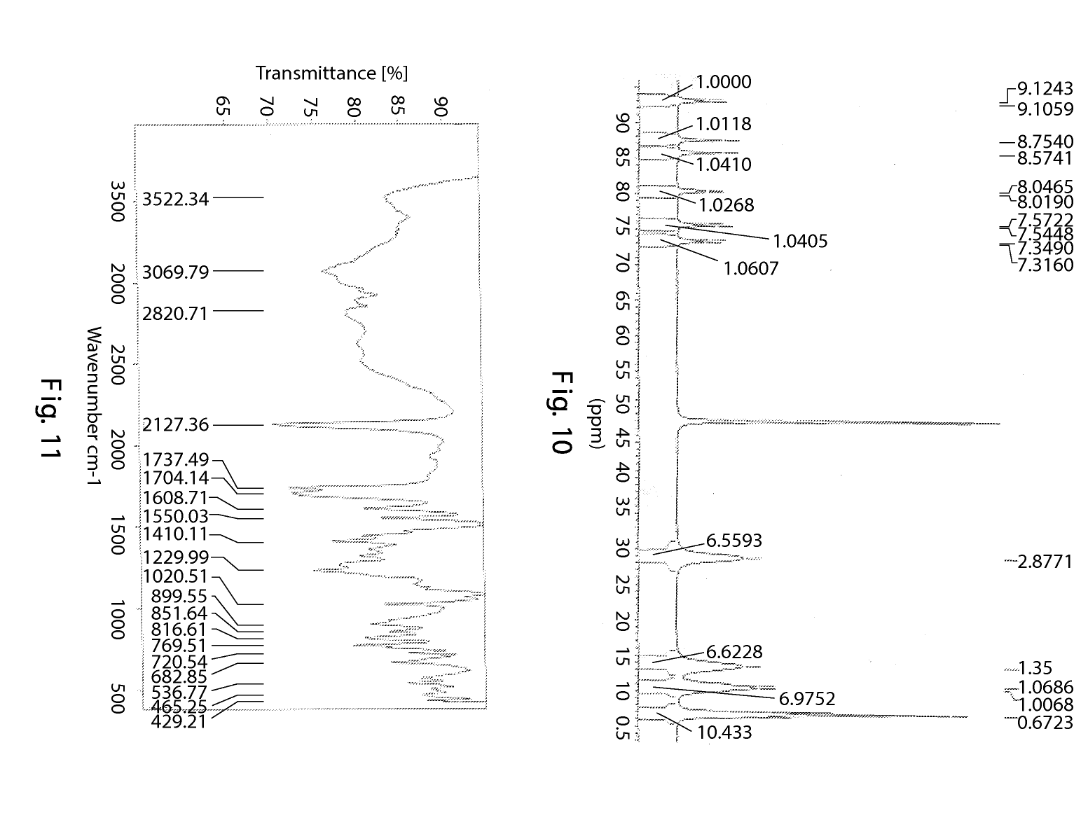

FIG. 11 shows FT-IR spectra of the complex Ru(II)(TBAHDCBPy)₂(NCS)₂(N719) from example 5;

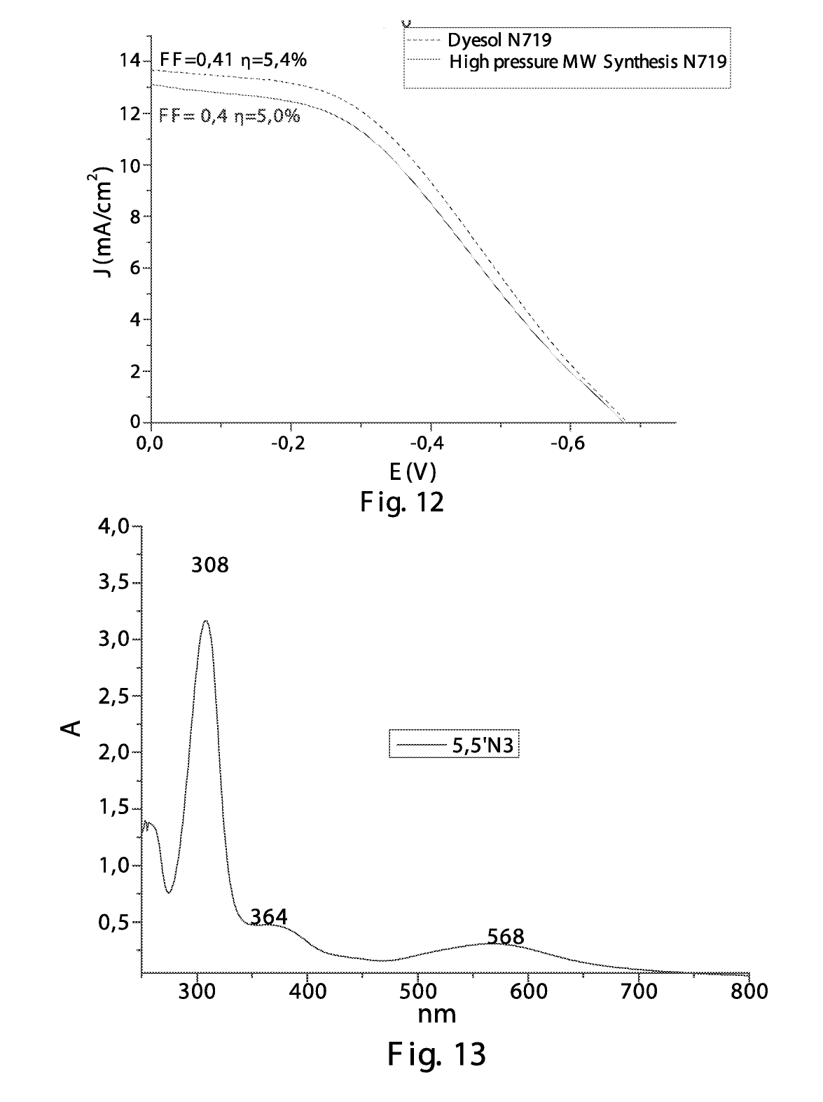

FIG. 12 shows J/V plot of the complex Ru(II)(TBAHDCBPy)₂(NCS)₂(N719) from example 5. compared to known art obtained complex;

FIG. 13 shows UV-Vis spectra in H₂O+NaOH of the complex Ru(II)(5.5′H₂DCBPy)₂(NCS)₂ (5,5′N3) from example 6;

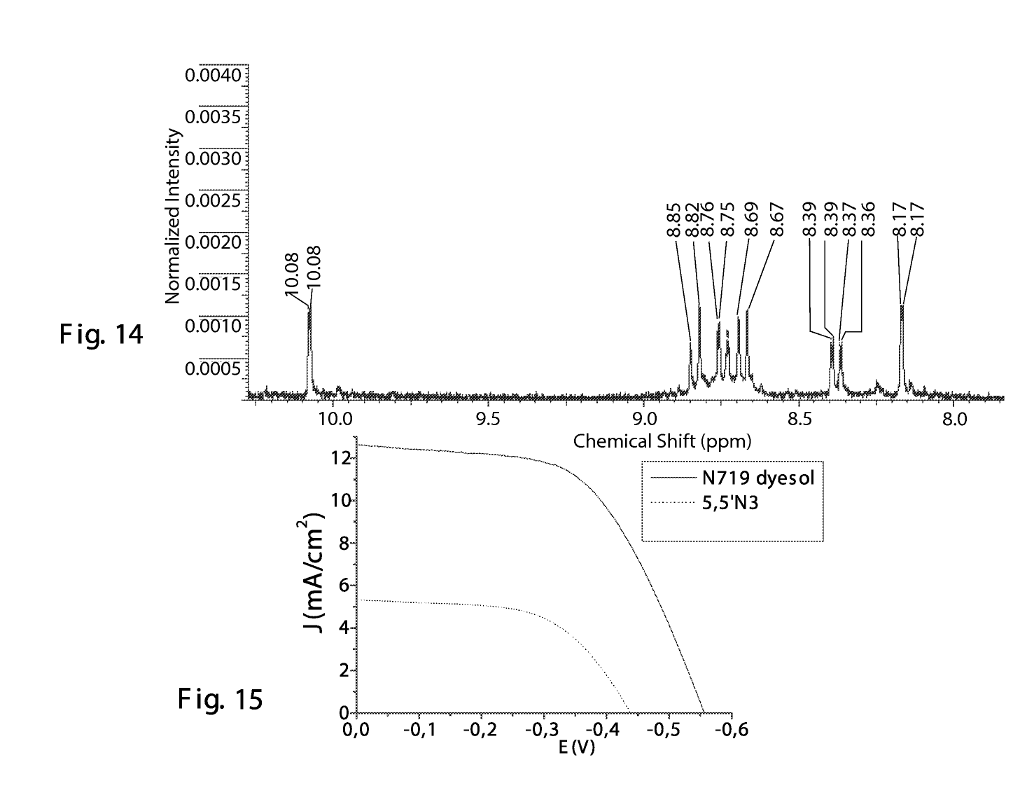

FIG. 14 shows ¹H NMR spectra in CD₃OD of the complex Ru(II)(5.5′H₂DCBPy)₂(NCS)₂ (5,5′N3) from example 6;

FIG. 15 shows J/V plot of the complex Ru(II)(5.5′H₂DCBPy)₂(NCS)₂ (5,5′N3) from example 6. compared to known art obtained complex;

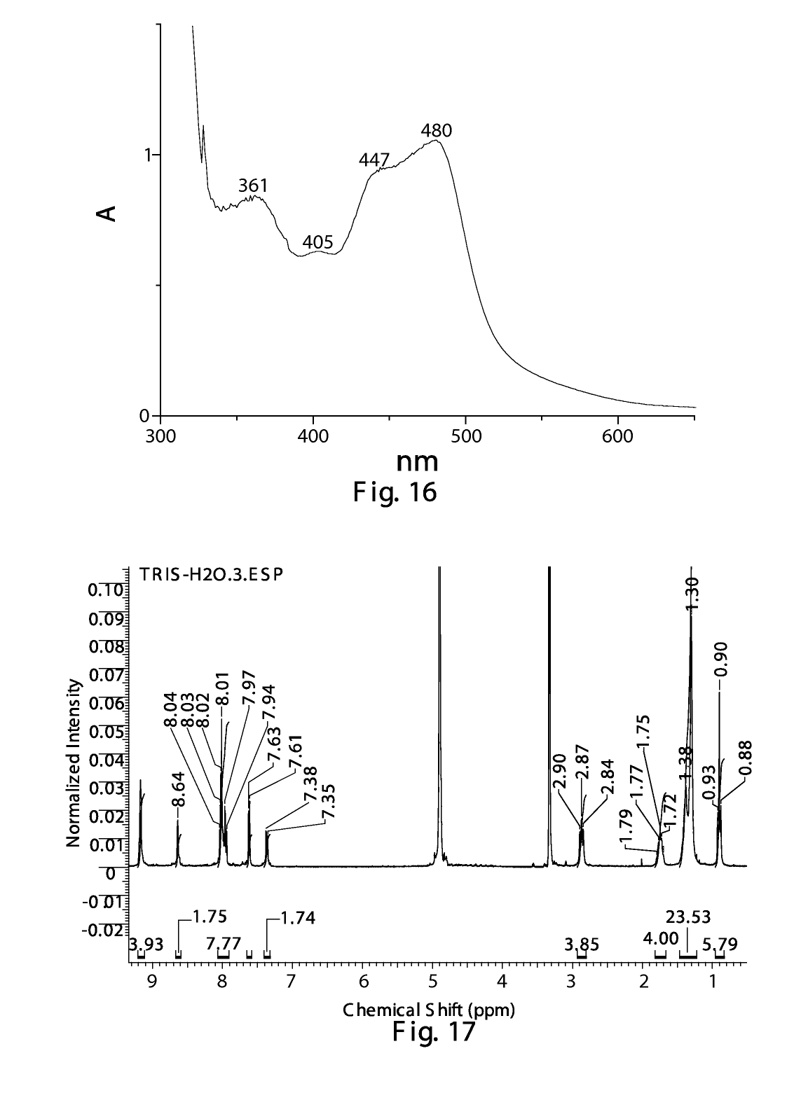

FIG. 16 shows UV-Vis spectra of [Ru(H₂dcbpy)₂(dnbpy)](PF₆)₂ complex from example 7;

FIG. 17 shows ¹H NMR spectra of the complex [Ru(H₂dcbpy)₂(dnbpy)](PF₆)₂ from example 7;

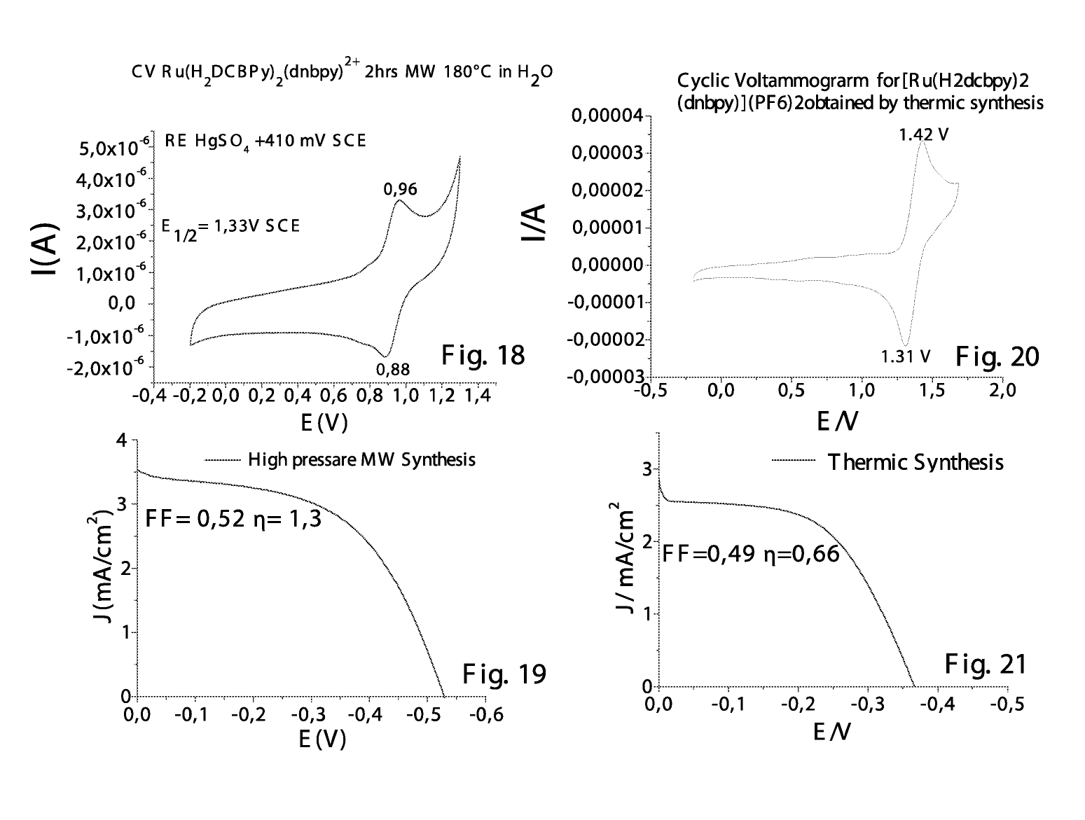

FIG. 18 shows cyclic voltammogram of the complex [Ru(H₂DCBPy)₂(dnbpy)]²⁺ obtained from MW (microwave) synthesis from example 7;

FIG. 19 shows J/V plot of the complex [Ru(H₂DCBPy)₂(dnbpy)]²⁺ obtained from MW (microwave) synthesis from example 7;

FIG. 20 shows cyclic voltammogram of the complex [Ru(H₂DCBPy)₂(dnbpy)]²⁺ obtained from thermal synthesis from comparative example 8;

FIG. 21 shows J/V plot of the complex [Ru(H₂DCBPy)₂(dnbpy)]²⁺ obtained from thermal synthesis from comparative example 8.

Particularly, in the following examples, according to an exemplary and not restrictive scope, precursor compounds of type cis-dichlorobis((4,4′-dicarboxy-2,2′-pyridyl)ruthenium (II), Ru(II)(H₂DCBPy)₂(Cl)₂ and cis-dichlorobis((5,5′-dicarboxy-2,2′-pyridyl)ruthenium (II) Ru(II)(5,5′H₂DCBPy)₂(Cl)₂ and dyeing sensitizers generated therefrom are considered:
1. cis-dithiocyanatebis(4,4′-dicarboxy-2,2′-pyridyl)ruthenium (II), Ru (II) (H₂DCBPy)₂ (NCS)₂ (N3) and corresponding deprotonated forms;
2. cis-dithiocyanatebis(5,5′-dicarboxy-2,2′-pyridyl)ruthenium (II), Ru (II) (5,5′H2DCBPy)2 (NCS)2 (5,5′-N3) and corresponding deprotonated forms;
3. [cis-Ru(H2DCBPy)2(dnbpy)]²+ (where dnbpy means 4,4′-dinonyl-2,2′-pyridyl).

The fact that, using microwave radiation, it is often possible the reaction times to be significantly reduced as well as product yield to be increased, is already known (Whittaker, G., Chemical Applications of Microwave Heating, 1997). About this matter, since 1986, more than 2000 papers in the organic synthesis field have been already published, particularly after the pioneering experimental works of Gedye and Majetich (Gedye, R. N., W. Rank and K. C. Westaway, Can. J. Chem., 69. 706. 1991) (Hicks, R. and. Majetich, G J. Microwave Power Electromagn. Eng., 30. 27. 1995) which demonstrated that microwaves could be successfully and reproducibly used to accelerate chemical reactions.

Indeed, initially, this technology did not receive much attention because of the poor process control and reliability. Successively the number of papers relating to Microwave Assisted Organic Synthesis (MAOS) exponentially increased and it is expected that the technological development will allow the production of microwave reactors suitable to be used on industrial scale, replacing traditionally heated reactors.

Another significant aspect, with reference to thermal traditional synthesis of the complexes type: Ru(LL)(X)₂ (X is selected from Cl, NCS, CN; and L is H₂DCBPy), is that said complexes are generally isolated by adding an acid to various Ru(LL)(X)₂⁴⁻ (X is selected from Cl, NCS, CN and L is DCBPy) anionic species, so as to obtain precipitation thereof at iso-electric point. This procedure involves a remarkable product loss due to the solubility of various molecular species under these conditions.

According to the present invention procedures involving the use of water based solvents and reaction carried out under high pressure in microwave reactor (MARS-MD), operating at 2450 MHz and 1600 W maximum power are described. Under these conditions, both cis-dichlorobis((4,4′-dicarboxy-2,2′-pyridyl)ruthenium (II) precursor and cis-dithiocyanatebis((4,4′-dicarboxy-2,2′-pyridyl)ruthenium (II) (N3) dye are directly obtained in solid form at their iso-electric point with high yields.

It is further to be pointed out that (Kohle; O.; Ruile, S.; Graetzel, M. Inorg. Chem. 1996. 35. 4779-4787), according to thermal traditional synthesis of N3 complex, starting from cis-[Ru(H₂DCBPy)₂Cl₂] and thiocyanate anion, can be formed not desired isomers, that is complexes wherein thiocyanate anion is coordinated by sulfur atom (S/S type or in a mixed way, i.e. by both sulfur and nitrogen atoms (N/S type). These isomers then must be separated through expensive chromatographic procedures, using size exclusion chromatography on Sephadex LH20 column. The use of high boiling point solvents as DMF allowed the reduction but not the elimination of these isomers.

The synthesis under high pressure water as described in this invention on the contrary resulted in the formation of a single N/N co-ordinated isomer as is shown by FT-IR (FIG. 5) and 1H NMR spectra (FIG. 8) as below reported.

In the below reported description further reference is made to [cis-Ru(H₂DCBPy)₂(dnbpy)]²⁺ (dnbpy means 4,4′-dinonyl-2,2′-pyridyl) complex, also obtained with high yield and high purity using the same synthetic process. With reference to said complex, microwave assisted synthesis under high pressure in water is clearly advantageous compared to thermal traditional synthesis. In addition to reduced reaction times with respect to thermal traditional synthesis (8 h against 2 h), the used precursor is the RuCl₃ species which is much less expensive than [Ru(p-cymene)Cl₂]₂ complex, necessary for conventional thermal synthesis. Finally, the synthetic product displays to be purer and with better electrophotochemical performances as shown in FIG. 19 and comparative FIG. 21. respectively.

The examples below describe the synthetic procedures which is the object of the present invention.

### EXAMPLE 1

### Synthesis of cis-dichlorobis((4,4′-dicarboxy-2,2′-pyridyl)ruthenium H₂DCBPy)₂Cl₂ Complex

In a reaction flask (HP500), RuCl₃ 3H₂O (100 mg; 0.38 mmol), H₂DCBPy (170 mg; 0.70 mmol), 3 ml of HCl (37%) and 3 ml of water are charged. The reactor temperature has been increased to 180° C. under a pressure of approximately 1400 kPa while the reactor power has been set at 800 W (magnetron frequency 2.45 GHz). These conditions are maintained for 30 min reaction time. After cooling to room temp., obtained red-orange obtained crystals are separated through filtration on porous glass filter (G4) and washed with 0.2M HCl solution. after oven drying 207 mg (yield=90%) have been obtained. UV-vis spectra in basic aqueous solution and ¹H NMR spectra in D₂O and NaOD of Ru (II) (H₂DCBPy)₂Cl₂ complex are reported in FIGS. 1 and 2, respectively.

### COMPARATIVE EXAMPLE 2

### Synthesis of Ru (II) (H2DCBPy)2Cl2 Complex According to Known Art

According to disclosure of European Patent Applications No. EP1798222 and No. EP2116534. the synthesis of Ru (II) (H₂DCBPy)₂Cl₂ has been carried out under nitrogen atmosphere, a 500 ml three neck flask is charged with commercially available RuCl₃ 3H₂O (2.53 g, 9.68 mmol), H2dcbpy (4.50 g, 18.4 mmol) and 300 ml of N,N-dimethylformamide and the mixture is heated under reflux under irradiation with 2.45 GHz microwave for 45 minutes. After cooling, the mixture is filtered and evaporated to dryness under vacuum. Obtained residue is washed with acetone/diethyl ether (1:4), after 300 ml of 2M hydrochloric acid are added and the mixture is sonicated under stirring for 20 minutes and then without ultrasounds for two hours. After the stirring, the insoluble material collected by filtration is washed with 2M hydrochloric acid, acetone/diethyl ether (1:4) and diethyl ether.

The synthetic process as reported in example 1 displays remarkable advantages compared to comparative example 2 although the microwave reaction times are comparable (30 min for example 1 and 45 min for example 2), the procedure described in example 1 involves the use of water and HCl solution as solvents instead of dimethylformamide (carcinogenic and expensive) and the desired product is obtained with 90% yield and collected using a quick work up involving simple cooling to room temp., the separation of semi-crystalline red-orange precipitate by filtration on porous glass filter and a washing with 0.2 HCl solution. The work up of comparative example 2 involves, after the cooling, DMF vacuum evaporation, successive acetone and diethyl ether washing, addition of 2M hydrochloric acid aqueous solution and stirring under ultrasounds for 20 minutes and further 20 minutes without ultrasounds, filtration and washings of the product with 2M hydrochloric acid, acetone/diethyl ether (1:4) and then diethyl ether with a 85% yield.

### EXAMPLE 3

### Synthesis of cis-dichlorobis((5,5′-dicarboxy-2,2′-pyridyl)ruthenium (II), Ru (II)5,5′H₂DCBPy)₂Cl₂ Complex

To high pressure HP500 reaction vessel containing 800 mg of RuCl₃ 3H₂O and 1.360 g of 5,5′H₂DCBPy, are added 25 ml of H₂O and 25 ml of 37% HCl. The reactor temperature has been increased at 180° C. under a pressure of approximately 1400 kPa while the reactor power has been set at 800 W (magnetron frequency 2.45 GHz). These conditions are maintained for a reaction time of 45 min under continuous stirring. After slow cooling to room temp., the obtained precipitate has been filtered on porous filter and washed with H₂O until to colourless washings. Obtained product has been oven dried (yield 78%).

FIG. 3 shows UV-vis spectroscopic characterization of obtained complex. It has not been possible to acquire ¹H NMR spectra due to complex high spin.

### EXAMPLE 4

### Synthesis of cis-dithiocyanatebis((4,4′-dicarboxy-2,2′-pyridyl)ruthenium (II), Ru (II)(H₂DCBPy)₂ (NCS)₂ Complex also Known as (N3)

In a reaction vessel (HP500) 200 mg (0.30 mmol) of cis-dichlorobis((4,4′-dicarboxy-2-2′-pyridyl)ruthenium (II), obtained in example 1 and 900 mg of NaNCS dissolved in 8 ml of water have been stirred. The reactor temperature has been increased at 130° C. under a pressure of approximately 1400 kPa while the reactor power has been set at 800 W (magnetron frequency 2.45 GHz). These conditions are maintained for a reaction time of 30 min. After cooling to room temp., the black precipitate obtained is separated by filtration on porous glass filter (G4), washed with water and dried obtaining 200 mg (85% yield). UV-Vis, FT-IR and ¹H NMR spectra of the product are shown in FIGS. 4. 5 and 8. respectively.

Using FT-IR and ¹H NMR spectra it has been observed that the reaction carried out under high pressure water using microwave heating resulted in the production of single N/N coordinated cis[Ru(H₂DCBPy)₂ (NCS)₂], isomer. In fact, analyzing FT-IR spectra in 2000-2200 cm⁻¹ range range, where absorption bands of the two thiocyanate groups occur, a single 2127 cm⁻¹ band is observed, as result of the presence of only N coordinated complex form. The presence of N/S coordinated isomer would result in absorption band doubling according to literature data (Kohle, O.; Ruile, S.; Graetzel, M. Inorg. Chem. 1996. 35. 4779-4787) and shown in FIG. 6 wherein 2000-2200 cm⁻¹ range of FT-IR spectra from example 4 (a) complex and, for comparison scope, coordinate sample thereof containing 21% S⁻ and 79%⁻ according to known art, are shown.

A further confirmation of the presence of cis[Ru(H₂DCBPy)₂ (NCS)₂], N/N coordinated complex as a single compound, obtained by the reaction as claimed by the present patent, results from ¹H NMR spectra. According to previously mentioned study (FIG. 7) during the conventional thermal reaction between Ru (II) (H₂DCBPy)₂Cl₂ complex and thiocyanate anion resulting in the formation of Ru (II) (H₂DCBPy)₂(NCS)₂. (N3), complex, according to the following scheme:

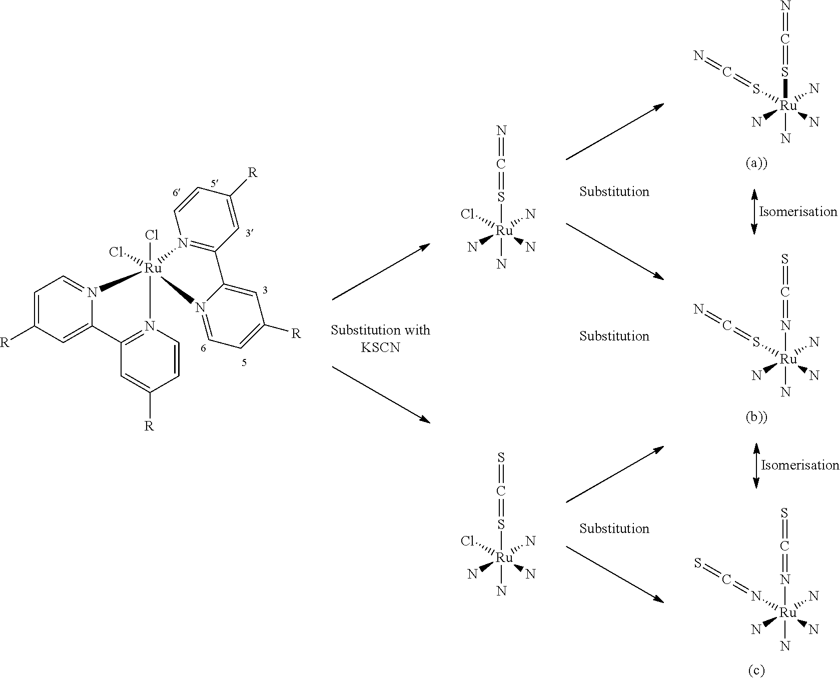

wherein (a) is S/S isomer, (b) is N/S isomer and (c) is N/N isomer, the chemical shift of number 6 named proton has been monitored.

During the reaction progress the appearance of various signals resulting from isomer formation as reported in the above reported reaction scheme has been observed. After 16 hours at 75° C. (reference g in FIG. 7) ¹H NMR spectra of reaction product proton 6 of Ru (II) (H₂DCBPy)₂ (NCS)₂ (N3) complex showed a strong signal attributed to N/N isomer and other two less intense signal attributed to the presence of N/S isomer.

In ¹H NMR spectra of FIG. 8 characteristic chemical shifts of Ru (II) (H₂DCBPy)₂ (NCS)₂. (N3) complex obtained through the synthesis according to the present patent application are reported. The absence of N/S isomers according to above reported. Proton 6 chemical shift is pointed out.

Thus synthesised N3 complex successively is converted in partially deprotonated form, named N719 according to literature procedures as below reported, for applications in photoelectrochemical field.

### EXAMPLE 5

### Conversion of N3 Complex in N719. (TBA)₂Ru((4-carboxy-4′carboxylate-2,2′-pyridyl) (NCS)₂ Ru (II) (TBAHDCBPy)₂(NCS)₂ Complex (N719)

100 mg (0.13 mmol) of Ru (II) (H₂DCBPy)₂(NCS)₂ (N3) are dissolved in 40 ml of water by dropwise addition of 40% tetrabutyl ammonium hydroxide (TBAOH) aqueous solution up to pH=7 as a stable value.

N719 complex has been precipitated by addition of 0.1 M nitric acid to above described solution up to pH 3.8. The precipitated is separated by filtration on porous glass filter (G4) and washed with nitric acid aqueous solution at pH=3.8. 85-90% yield.

The complex has been fully characterized both from spectroscopic and photoelectrochemical.

FIGS. 9. 10. 11 and 12 show Uv-Vis, ¹H NMR, FT-IR spectra and JV plots of obtained complex, respectively.

Particularly, FIG. 12 shows J/V plots for N719 DYESOL Company (dotted line) complex and compound obtained using microwave assisted synthesis under high pressure in water (continuous line) under simulated AM 1.5 (70 mW cm⁻²) irradiation conditions according to the following set up. Pt Cathode. Transparent TiO₂. Electrolyte composition N-propyl-N-methyl imidazole iodide 0.6M, LiI 0.1 M, tert-butylpyridine 0.5M, iodine 0.2M in methoxypropionitrile.

Photovoltaic parameters corresponding to FIG. 12 (Jsc, Voc, FF, and η are respectively: 13.12 mA cm⁻² 677 mV, 0.4 and 5% for N719 complex obtained according to the present invention using microwave assisted synthesis under high pressure in water and 13.69 mA cm⁻² 682 mV, 0.41 and 5.4% for N719 complex obtained according to known art (DYESOL).

### EXAMPLE 6

### Synthesis of cis-dithiocyanatebis((5,5′-dicarboxy-2,2′-pyridyl)ruthenium (II) complex Ru (II) (5.5′ H2DCBPy)₂ (NCS)₂ (5,5′N3)

1.4 g (2.12moles) of Ru(5,5′H₂DCBPy)₂Cl₂ obtained according to the process under high pressure water from example 3 and 10 g of NaNCS are charged in a high pressure microwave reaction HP500 reactor and 50 ml of H₂O are then added. The reactor temperature has been increased at 130° C. and the reactor power has been set at 800 W (magnetron frequency 2.45 GHz). These conditions are maintained for a reaction time of 45 min under continuous stirring. After slow cooling to room temp., the obtained precipitated has been filtered on porous filter and washed with H₂O and pH=3.8 HClO₄ aqueous solution until colourless washings. The obtained product has been oven dried (85% yield).

FIGS. 13. 14 and 15 show Uv-Vis, ¹H NMR spectra and JV plots of obtained complex, respectively.

Particularly, FIG. 15 shows J/V plots for N719 DYESOL Company (continuous black line) complex and 5,5′-N3 complex obtained using microwave assisted synthesis under high pressure water under simulated AM 1.5 (70 mW cm⁻²) irradiation conditions according to the following set up. Cathode: potentiostatically electrocoated PEDOT (20″) (polyethylene dioxide thiophene) FTO (4.9mF/cm²). Electrolyte composition N-propyl-N-methyl imidazole iodide 0.6M, LiI 0.1 M, tert-butylpyridine 0.5M, iodine 0.2M in methoxypropionitrile.

Photovoltaic parameters corresponding to FIG. 16 (Jsc, Voc, FF, and η are respectively: 5.32 mA cm⁻² 440 mV, 0.57 and 2.0% for 5,5′ N3 complex obtained according to the present invention by synthesis under high pressure water with microwave heating and 12.67 mA cm⁻² 559 mV, 0.55 and 5.8% for N719 DYESOL standard complex.

### EXAMPLE 7

### Synthesis of [cis-Ru(H₂DCBPy)₂(dnbpy)]²⁺(dnbpy=4,4′-dinonyl-2,2′-pyridyl) complex

100 mg (0.15 mmol) of cis-dichlorobis((4,4′-dicarboxy-2,2′-pyridyl)ruthenium (II), obtained using high pressure synthesis as reported in example 1 and 61.8 mg (0.15 mmol) of dnbpy suspended in 12 ml of water are added to a reaction vessel (HP500). The reactor temperature of the reactor has been increased at 180° C. under a pressure of approximately 1400 kPa while the power of the reactor has been set at 800 W (magnetron frequency 2.45 GHz). These conditions are maintained for a reaction time of 120 minutes. After cooling to room temp. obtained precipitated is separated by filtration through porous glass filter (G4), dissolved in basic water, filtered and precipitated by addition of HPF₆ aqueous solution at about pH 2. 150 mg (77% yield) of solid crystalline a red crystalline solid have been obtained. The obtained product, without further purification, is characterized by UV-vis spectroscopy (FIG. 16), ¹H NMR (FIG. 17), as well as CV cyclic voltammetric (FIG. 18) and photoelectrochemical measures (JV plot in FIG. 19).

Particularly, FIG. 18 shows cyclic voltammogram for [cis-Ru(H₂DCBPy)₂(dnbpy)]²⁺ product obtained using microwave reactor under high pressure water according to the following experimental conditions: electrolytic solution: LiClO₄ 0.1 M in acetonitrile, working electrode: glassy carbon, reference electrode: Hg/HgSO₄.

FIG. 19 shows DSSC JV plot for [cis-Ru(H₂DCBPy)₂(dnbpy)]²⁺ dye obtained according to the present invention by microwave synthesis (AM 1.5 (74 mW cm⁻²) under following simulated experimental irradiation conditions (AM 1.5 (74 mW cm⁻²): Mediator/electrolyte: Co(DTB)₃(OTf)₂ 0.15M, Fe(DMB)₃(PF₆)₂ 0.015M, Li(OTf) 0.5M in acetonitrile. (DTB=4,4′-dimethyl-2,2′-bipyridyl, DMB=4,4′-diterbutyl-2,2′-bipyridyl, OTf=p-toluenesulphonate). Cathode: potentiostatically (15 s) electrocoated PEDOT (20″) (polyethylene dioxide thiophene) FTO. Transparent TiO₂. Photovoltaic parameters corresponding to FIG. 19 (Jsc, Voc, FF, e η) are respectively: 3.53 mA cm⁻², 531 mV, 0.52 and 1.3%.

### COMPARATIVE EXAMPLE 8

### Thermal Synthesis of [cis-Ru(H₂DCBPy)₂(dnbpy)]²⁺(dnbpy=4,4′-dinonyl-2,2′-pyridyl) Complex

0.3 g (0.49 mmol) of [Ru(p-cymene)₂Cl₂]₂ are added to 60 ml of DMF under nitrogen inert atmosphere at atmospheric pressure, to this solution 0.4 g (0.98 mmol) of 4,4′-dinonyl-2,2′-pyridyl(dnbpy) are added and the resultant mixture is heated at 60° C. for 2 h. Successively 0.24 g (0.98 mmol) of 4,4′-dicarboxy-2,2′-pyridyl (H₂dcbpy) are added and the reaction mixture is heated under reflux (160° C.) for 4 h. 0.24 g (0.98 mmol) of Hdcbpy₂ and 0.157 g (3.9 mmol) of NaOH are dissolved in 3 ml of water and then added to reaction mixture then refluxed over further 2 h.

The reaction mixture is hot filtered and the solvent is removed under vacuum evaporation. Obtained solid is dissolved in basic NaOH solution and the product precipitated at pH=2 by addition of aqueous HPF₆ solution. The dissolution and precipitation procedures are repeated two times, the precipitate is washed with aqueous HPF₆ solution and finally with ethyl ether. Yield 60%.

The resulting product, without further purifications, is characterized by cyclic voltammetry (FIG. 20) and JV plot (FIG. 21).

Particularly, FIG. 20 shows cyclic voltammogram of [cis-Ru(H₂DCBPy)₂(dnbpy)]²⁺ product obtained according to the conventional thermal synthesis under the following experimental conditions: electrolytic solution: LiClO₄ 0.1 M in acetonitrile, working electrode: glassy carbon, reference electrode: SCE.

FIG. 21 shows DSSC JV plot for [cis-Ru(H₂DCBPy)₂(dnbpy)]²⁺ dye obtained according to known art by thermal synthesis under following simulated experimental irradiation conditions (AM 1.5 75 mW cm⁻²): Mediator/electrolyte: Co(DTB)₃ (OTf)₂ 0.15M, Fe(DMB)₃ (PF₆)₂ 0.015M, Li (OTf) 0.5M in acetonitrile. (DTB=4,4′-dimethyl-2,2′-bipyridyl, DMB=4,4′-diterbutyl-2,2′-bipyridyl, OTf=p-toluenesulphonate). Cathode: potentiostatically (15 s) electrocoated PEDOT (polyethylene dioxide thiophene) FTO. Transparent TiO₂. Photovoltaic parameters corresponding to FIG. 21 (Jsc, Voc, FF, e η) are respectively: 2.56 mA cm⁻² 369 mV, 0.49 and 0.66%.

The synthesis carried out according to methodology described in example 7 using a microwave reactor (magnetron frequency 2.45 GHz) in water based solvent under pressure resulted in better results than thermal traditional synthesis as described in example 8. In addition to reduced reaction times and better photoelectrochemical performances, as shown in FIGS. 19 and 21, it is used like precursor RuCl₃ compound which is much less expensive than [Ru(p-cymene)Cl₂]₂ needed for conventional thermal synthesis as reported in example 8.

In conclusion, the use of a microwave source (magnetron frequency 2.45 GHz), in combination with the aqueous synthesis in pressurized environment (not carcinogenic and very cheap) resulted in the synthesis of cis-dichlorobis((4,4′-dicarboxy-2,2′-pyridyl)ruthenium (II) Ru(II)(H₂DCBPy)₂(Cl)₂ precursor and cis-dithiocyanate ((4,4′-dicarboxy-2,2′-pyridyl)ruthenium (II), Ru(II)(H₂DCBPy)₂(NCS)₂ (N3) and [cis-Ru(H₂DCBPy)₂(dnbpy)]²⁺(dnbpy=4,4′-dinonyl-2,2′-pyridyl) dyes with high yields,very short reaction times and shortened and simplified isolation procedures (reaction work up) compared to both thermal and microwave assisted syntheses in dimethylformamide carried out at atmospheric pressure.

The same synthetic methodology has been also successfully used for the synthesis of analogous complexes wherein 5,5′-dicarboxy-2,2′-bipyridyl- is used instead of 4,4′-dicarboxy-2,2′-bipyridyl.

The described synthetic procedures appear to be completely general and applicable to large classes of Ru (II) metal-organic complexes and are moreover at low environmental impact as a toxic solvents like dimethylformamide, employed for traditional thermal syntheses, are replaced by water based ones. The synthesized compounds are isolated through simple procedures like filtration and are spectroscopically pure without the use of expensive chromatographic purification methods. The DSSC cell performances of dyes synthesized with microwave methodology under high pressure water based solvent according to the present invention proved to be comparable or better than corresponding dyes obtained by classic thermal synthesis.

The present invention has been described by an illustrative but not limitative way according to preferred embodiments thereof but it is to be understood that variations and/or modifications could be carried out by those skilled in the art without departing from the scope thereof, as defined according to the enclosed claims.

What is claimed is:

1. Synthesis in aqueous media of both precursor complexes and dye sensitizers for titanium dioxide based on ruthenium polypyridine complexes of general formula RuLL′X₂, RuLX₃ or Ru LL′L″ where L, L′, L″ is a bidentate or tridentate organic ligand which can be chosen among H₂dcbpy 4,4′-dicarboxy-2-2′-bipyridyl, 5,5′-dicarboxy-2,2′-bipyridyl, 4,4′,4″-tricarboxy-2,2′,6′,2″-terpyridyl, 4,4′-dinonyl-2,2′-bipyridyl, 4,4′-bis-3,4-dioctyloxystyryl-2,2′-bipyridyl, 6-phenyl-2,2′-bipyridyl, 6-(2,4-difluorophenyl)-2,2′-bipyridyl; the ruthenium precursor complexes can be RuCl₃.3(H₂O) [RuCl₆]²⁻, [Ru(DMSO)₆(Y)₂] wherein Y is selected from PF₆, ClO₄, Cl, Br; X is an anionic ligand selected from NCS⁻, Cl⁻, CN⁻. The microwave irradiation, whose frequency is comprised from 300 MHz to 300 GHz, is applied in a high pressure vessel (HP500) contained in a multimodal or unimodal MW reactor, at pressure values of 690 kPa to 5500 kPa.

2. The synthesis process according to claim 1, wherein used precursors are dissolved in an amount of 60-70 ml/g of metallic precursor in a solution comprising from 20 to 100 wt % of water and from 0 to 80% of HCl (37%).

3. The synthesis process according to claim 1 or 2, wherein said microwave irradiation occurs at a temperature comprised between 80 and 250° C., with a power comprised between 400 and 1600 W for a time comprised between 10 and 60 minutes.

4. The synthesis process according claim 1 wherein following said microwave irradiation, the synthesis products are cooled down to ambient temperature, separated by filtration, washed with water or with a solution of HCl and dried.

5. The synthesis process according to claim 1 wherein it further comprises the following terminal steps: microwave irradiation, of frequency being comprised between 300 MHz and 300 GHz, in high pressure vessel, at pressure being comprised between 690 and 5500 kPa and in aqueous environment, of complexes obtained according to process steps defined according to claims 1-4, in the presence of NCS— or CN— salts (from 10 to 50 equivalents) or chelating chromophore ligand based on polypyridine, polytriazole, polytetrazole and acetylacetonate derivatives (from 1 to 4 equivalents).

6. The synthesis process according to claim 5, wherein said further microwave irradiation step is carried out at a temperature comprised between 80 and 250° C., at a power comprised between 400 and 1600 W for a time comprised between 10 and 60 minutes.

7. The synthesis process according to claim 6, wherein following said further microwave irradiation step, the synthesis products are cooled down to ambient temperature, separated by precipitation, washed and dried.

8. A process for the synthesis in aqueous media of precursor complexes and dye sensitizers for titanium dioxide based on ruthenium polypyridine complexes, the process comprising:
i. selecting a ruthenium polypyridine complex selected from the group consisting of RuLL′X2, RuLX3 or Ru LL′L″, wherein
a. each of L, L′, and L″ is a bidentate or tridentate organic ligand selected from the group consisting of H2dcbpy 4,4′-dicarboxy-2-2′-bipyridyl, 5,5′-dicarboxy-2,2′-bipyridyl, 4,4′,4″-tricarboxy-2,2′,6′,2″-terpyridyl, 4,4′-dinonyl-2,2′-bi pyridyl, 4,4′-bis-3,4-dioctyloxystyryl-2,2′-bipyridyl, 6-phenyl-2,2′-bipyridyl, 6-(2,4-difluorophenyl)-2,2′-bipyridyl; and
b. X is an anionic ligand; and
ii. irradiating said ruthenium polypyridine complex via microwave at a frequency of 300 MHz to 300 GHz in a high pressure vessel at a pressure of 690 kPa to 5500 kPa.

9. The synthesis process according to claim 8, wherein the used precursors are dissolved in an amount of 60 ml/g to about 70 ml/g of a metallic precursor in a solution from 20 wt % to 100 wt % water and from 0% to 80% of HCl (37%).

10. The synthesis process according to claim 8, wherein said irradiating via microwave occurs at a temperature from 80° C. to 250° C., at a power of 400 W to 1600 W, and for a time of 10 minutes to 60 minutes.

11. The synthesis process according to claim 8, further comprising cooling the synthesized products to ambient temperature, filtrating said synthesized products to separate said synthesized products, and washing said synthesized products with water or a solution of HCl, and drying said synthesized products.
